(19) United States
(12) Patent Application Publication
(10) Pub. No.: US 2026/0089027 A1
(43) Pub. Date: Mar. 26, 2026

(54) SYSTEMS, APPARATUSES AND METHODS FOR MANAGING AND ROUTING DATA IN A MULTI-TIER NETWORK ARCHITECTURE

(71) Applicant: HUAWEI TECHNOLOGIES CO., LTD., Shenzhen (CN)

(72) Inventors: Amr Adel Nasr Abdelnasser, Vancouver (CA); Xingjun Chu, Ottawa (CA); Ashkan Sobhani, Ottawa (CA)

(21) Appl. No.: 18/893,112

(22) Filed: Sep. 23, 2024

(51) Int. Cl. H04L 12/44; H04L 45/02; H04L 45/24

(52) U.S. Cl. CPC H04L 12/44; H04L 45/025; H04L 45/08; H04L 45/24

(57) ABSTRACT

Methods, systems, and apparatuses are provided for managing and routing data in a multi-tier network architecture. The methods include transmitting a data flow comprising a sequence of data packets to a source leaf switch and determining if an intended route exists in a forwarding table stored at the source leaf switch using routing metadata. If the intended route does not exist, a control packet is transmitted to a centralized coordinator switch, which modifies an allocation table to include an updated route. The forwarding table at the source leaf switch is then updated with the updated route, and the data flow is transmitted to its destination.

### FIELD OF THE DISCLOSURE

The present disclosure relates generally to systems, apparatuses, and methods for network management and data routing, and more particularly to systems, apparatuses, and methods for managing and routing data in a multi-tier network architecture through centralized coordination and dynamic updating of routing tables.

### BACKGROUND

The advent of big data technologies has facilitated the training of sophisticated machine learning models on expansive datasets. These developments permit the processing and analysis of substantial quantities of data, which are essential for the development of sophisticated machine learning algorithms. However, the training of such extensive models frequently necessitates the allocation of substantial memory and computing resources, which can render their execution within a single unit challenging.

The use of distributed machine learning (DML) has emerged as a prominent approach to address the aforementioned challenges by leveraging the capabilities of multiple computing resources. This technique distributes the workload across multiple computing units, thereby facilitating the efficient processing of extensive data. By concurrently analyzing smaller subsets of data, distributed machine learning (DML) enables the integration of results from disparate computing resources to generate a unified final output. This approach is especially valued for its capacity to reduce time and cost in data processing while enhancing the scalability, speed, and efficiency of machine learning algorithms.

### SUMMARY

According to one aspect of this disclosure, there is provided a method for routing data in a multi-tier network architecture, comprising: transmitting a data flow to a source leaf switch of a plurality of leaf switches in the multi-tier network architecture, the data flow comprising a sequence of data packets; determining if an intended route for the data flow exists in a forwarding table stored at the source leaf switch using routing metadata from at least one of the data packets; in response to determining that the intended route does not exist in the forwarding table, transmitting a control packet to a centralized coordinator switch; modifying an allocation table stored at the centralized coordinator switch to include an updated route for the data flow based on current network conditions; updating the forwarding table stored at the source leaf switch using the updated route; and transmitting the data flow to a destination node according to the updated forwarding table.

In some embodiments, modifying the allocation table may comprise utilizing a loop algorithm to determine the updated route for the data flow.

In some embodiments, the routing metadata may include five-tuple information on source IP address, destination IP address, source port number, destination port number, and protocol.

In some embodiments, updating the forwarding table may comprise updating the forwarding table stored at each of the plurality of leaf switches.

In some embodiments, the method may further comprise: classifying the data flow as a mice flow or an elephant flow based on a size of the data flow; and in response to the data flow being classified as the mice flow, routing the data flow according to an Equal-Cost Multi-Path (ECMP) or Hop-by-hop Utilization-aware Load balancing Architecture (HULA) scheme.

In some embodiments, the multi-tier network architecture may comprise a first tier and a second tier, the first tier comprising the plurality of leaf switches and the second tier comprising a plurality of spine switches, the centralized coordinator switch being one of the plurality of spine switches.

In some embodiments, the multi-tier network architecture may comprise a plurality of layers to allow simultaneous data transmission via a same route on corresponding layers, and wherein the allocation table may further comprise a sending layer table and a receiving layer table for determining which of the plurality of layers the data flow is to use.

In some embodiments, the multi-tier network architecture may comprise a first tier comprising the plurality of leaf switches, a second tier comprising a plurality of spine switches, and a third tier comprising a plurality of core switches, the centralized coordinator switch being one of the plurality of core switches.

In some embodiments, the method may further comprise updating the forwarding table stored at each of the spine switches using the updated route.

In some embodiments, a first number of the spine switches and a first number of the core switches may be grouped as a first group, and a second number of the spine switches and a second number of the core switches may be grouped as a second group, and the control packet may comprise a first control packet and a second control packet, the first control packet being transmitted to the centralized coordinator switch acting as a first-stage coordinator for determining whether the first group or the second group is included in the updated route, the second control packet being transmitted to one of the core switches in the determined first or second group acting as a second-stage coordinator for determining which of the plurality of core switches is included in the updated route.

In some embodiments, the plurality of leaf switches and the plurality of spine switches may be grouped as a plurality of pods, each comprising at least two of the plurality of leaf switches and at least two of the plurality of spine switches, and the control packet may be transmitted to the centralized coordinator switch for determining which of the plurality of pods are included in the updated route.

In some embodiments, the multi-tier network architecture may comprise a first tier and a second tier, the first tier comprising the plurality of leaf switches and the second tier comprising a plurality of spine switches, the multi-tier network architecture may comprise a plurality of physical links between each of the plurality of the leaf switches and each of the plurality of spine switches to allow simultaneous data transmission via a same route on corresponding physical links, and the allocation table may further comprise a link index for determining which of the plurality of physical links the data flow is to use.

In some embodiments, each of the plurality of spine switches may be configured to forward the data flow based on a predetermined rule such that the data flow is received and forwarded out on the same link index.

In some embodiments, the method may further comprise: in response to completing the transmission of the data flow, retaining the forwarding table for a predetermined period; and erasing information on the data flow from the allocation table to free up resources for future routing tasks.

According to another aspect of this disclosure, there is provided a network system comprising: a plurality of leaf switches and a centralized coordinator switch, the leaf switches and the centralized coordinator switch being part of a multi-tier network architecture; wherein a source leaf switch of the plurality of leaf switches comprises: a packet receiver for receiving a data flow comprising a sequence of data packets; a leaf storage unit, in which a forwarding table is stored; and a leaf control unit adapted to determine if an intended route for the data flow exists in the forwarding table using routing metadata from at least one of the data packets, and, in response to determining that the intended route does not exist in the forwarding table, to generate a control packet that is to be transmitted to the centralized coordinator switch; wherein the centralized coordinator switch comprises: a coordinator storage unit, in which an allocation table is stored; and a coordinator control unit adapted to modify the allocation table to include an updated route for the data flow based on current network conditions, and to transmit the updated route to the source leaf switch; and wherein the leaf control unit of the source leaf switch is further adapted to update the forwarding table using the updated route, and to transmit the data flow to a destination node according to the updated forwarding table.

In some embodiments, the allocation table may be modified by utilizing a loop algorithm to determine the updated route for the data flow.

In some embodiments, the routing metadata may comprise five-tuple information including source IP address, destination IP address, source port number, destination port number, and protocol.

In some embodiments, the coordinator control unit may be further adapted to transmit the updated route to each of the plurality of leaf switches, and the leaf control unit of each of the plurality of leaf switches may be adapted to update its forwarding table.

In some embodiments, the source leaf switch may further comprise a classification unit configured to classify the data flow as a mice flow or an elephant flow based on a size of the data flow; and wherein the data flow may be routed according to an Equal-Cost Multi-Path (ECMP) or Hop-by-hop Utilization-aware Load balancing Architecture (HULA) scheme in response to the data flow being classified as the mice flow.

In some embodiments, the multi-tier network architecture may comprise: a first tier comprising the plurality of leaf switches; and a second tier comprising a plurality of spine switches, wherein the centralized coordinator switch is one of the plurality of spine switches.

In some embodiments, the multi-tier network architecture may comprise: a plurality of layers for allowing simultaneous data transmission via a same route on corresponding layers, wherein the allocation table further comprises a sending layer table and a receiving layer table for determining which of the plurality of layers the data flow is to use.

In some embodiments, the multi-tier network architecture may comprise: a first tier comprising the plurality of leaf switches; a second tier comprising a plurality of spine switches; and a third tier comprising a plurality of core switches, wherein the centralized coordinator switch is one of the plurality of core switches.

In some embodiments, the forwarding table stored at each of the spine switches may be updated using the updated route.

In some embodiments, a first number of the spine switches and a first number of the core switches may be grouped as a first group, and a second number of the spine switches and a second number of the core switches may be grouped as a second group, and the control packet may comprise a first control packet and a second control packet, the first control packet being transmitted to the centralized coordinator switch acting as a first-stage coordinator for determining whether the first group or the second group is included in the updated route, the second control packet being transmitted to one of the core switches in the determined first or second group acting as a second-stage coordinator for determining which of the plurality of core switches is included in the updated route.

In some embodiments, the plurality of leaf switches and the plurality of spine switches may be grouped as a plurality of pods, each pod comprising at least two of the plurality of leaf switches and at least two of the plurality of spine switches, and the control packet may be transmitted to the centralized coordinator switch for determining which of the plurality of pods are included in the updated route.

In some embodiments, the multi-tier network architecture may comprise a first tier and a second tier, the first tier comprising the plurality of leaf switches and the second tier comprising a plurality of spine switches, the multi-tier network architecture may comprise a plurality of physical links between each of the plurality of the leaf switches and each of the plurality of spine switches to allow simultaneous data transmission via a same route on corresponding physical links, and the allocation table may further comprise a link index for determining which of the plurality of physical links the data flow is to use.

In some embodiments, each of the plurality of spine switches may be configured to forward the data flow based on a predetermined rule such that the data flow is received and forwarded out on the same link index.

In some embodiments, the leaf control unit of the source leaf switch may be further adapted to, in response to completing the data transmission, retain the forwarding table for a predetermined period, and the coordinator control unit of the centralized coordinator switch may be further adapted to, in response to completing the transmission of the data flow, erase information on the data flow from the allocation table to free up resources for future routing tasks.

According to another aspect of this disclosure, there is provided an apparatus comprising: a coordinator storage unit, in which an allocation table is stored; and a coordinator control unit adapted to: receive a control packet from a source leaf switch of a plurality of leaf switches in a multi-tier network architecture, the control packet being generated in response to the source leaf switch determining that an intended route for a data flow comprising a sequence of data packets does not exist in a forwarding table stored at the source leaf switch using routing metadata from at least one of the data packets; modify the allocation table to include an updated route for the data flow based on current network conditions; and transmit the updated route to the source leaf switch.

In some embodiments, the allocation table may be modified by utilizing a loop algorithm to determine the updated route for the data flow.

In some embodiments, the routing metadata may comprise five-tuple information including source IP address, destination IP address, source port number, destination port number, and protocol.

In some embodiments, the coordinator control unit may be further adapted to transmit the updated route to each of the plurality of leaf switches for updating their respective forwarding tables.

In some embodiments, the multi-tier network architecture may comprise: a first tier comprising the plurality of leaf switches; and a second tier comprising a plurality of spine switches, wherein the apparatus is one of the plurality of spine switches.

In some embodiments, the multi-tier network architecture may comprise: a plurality of layers for allowing simultaneous data transmission via a same route on corresponding layers, wherein the allocation table further comprises a sending layer table and a receiving layer table for determining which of the plurality of layers the data flow is to use.

In some embodiments, the multi-tier network architecture may comprise: a first tier comprising the plurality of leaf switches; a second tier comprising a plurality of spine switches; and a third tier comprising a plurality of core switches, wherein the apparatus is one of the plurality of core switches.

In some embodiments, the coordinator control unit may be further adapted to transmit the updated route to each of the plurality of spine switches for updating their respective forwarding tables.

In some embodiments, the multi-tier network architecture may comprise a first tier and a second tier, the first tier comprising the plurality of leaf switches and the second tier comprising a plurality of spine switches, the multi-tier network architecture may comprise a plurality of physical links between each of the plurality of the leaf switches and each of the plurality of spine switches to allow simultaneous data transmission via a same route on corresponding physical links, and the allocation table additionally may comprise a link index for determining which of the plurality of physical links the data flow is to use.

In some embodiments, the coordinator control unit may be further adapted to, in response to completing the transmission of the data flow, erase information on the data flow from the allocation table to free up resources for future routing tasks.

The methods, apparatus, and systems described herein offer various technical advancements that improve the management of data flows in complex, multi-tier network architectures. One benefit is the ability to optimize load balancing (LB) through a centralized, coordinated mechanism, which dynamically adjusts routing paths based on real-time network conditions to enhance overall throughput and reduce latency in high-traffic environments such as data centers. This coordinated approach, in some embodiments, incorporates the use of a loop algorithm, ensuring efficient distribution of both mice and elephant flows while reducing congestion and flow collisions. Additionally, in some embodiments, by classifying data flows into mice and elephant flows, the system can apply tailored routing strategies to improve the efficiency of data transmission for all data flows.

Some variants described herein introduce a flexible, multi-tier network architecture that supports a range of configurations, including two-tier, three-tier, or even more complex systems. The architecture is scalable and can accommodate evolving network requirements, allowing seamless expansion and management of large-scale networks. For example, some embodiments employ sending and receiving layer tables to support multi-layered data transmission, enabling multiple flows to traverse the same routes. This layered approach provides increased network capacity and resource efficiency, making it possible to handle larger volumes of data while minimizing flow collisions. These features are particularly beneficial in environments where data flow demands are constantly fluctuating.

Some other variants described herein further extend the network's flexibility and adaptability. For instance, the use of multi-link connections between tiers, along with the option to assign link indices for efficient routing, enables simultaneous data transmission across multiple physical links, ensuring balanced network utilization. Additionally, the architecture can be configured to group spine and core switches into hierarchical structures or pods, with each group or pod managed by separate first- or second-stage coordinators. These optional configurations allow for greater customization and enhanced load distribution, ensuring that the network can be tailored to different deployment scenarios.

The above-described methods, apparatus, and systems of the present disclosure provide solutions with notable advantages by significantly enhancing network functionality and efficiency, particularly in data center environments. The solutions result in optimized data flow distribution, reduced congestion, and improved overall network performance while accommodating a wide range of data traffic conditions. The solutions may also provide scalability and adaptability for complex network architectures, ensuring that they can effectively manage varying and evolving network requirements. By integrating these advances into network management, the solutions reduce operational overhead and increase reliability, making them well suited for managing high-density traffic in practical, real-world applications.

### BRIEF DESCRIPTION OF THE DRAWINGS

For a more complete understanding of the disclosure, reference is made to the following description and accompanying drawings, in which:

FIG. 1 is a schematic diagram of a network system implementing a two-tier single-link leaf-spine topology commonly used in data center networks, according to some embodiments of this disclosure.

FIG. 2 is a flowchart illustrating the overall operation of the Coordinated Load Balancing (CLB) mechanism within a data center network (DCN), according to some embodiments of this disclosure.

FIG. 3 is a flowchart showing the sequence of operations performed by a leaf switch when a data packet belonging to a specific flow arrives, according to some embodiments of this disclosure.

FIG. 4A is a schematic diagram of an unfolded version of the two-tier topology shown in FIG. 1.

FIG. 4B is an example coordinator allocation table used by the coordinator to track and manage the allocation of flows to spine switches, according to some embodiments of this disclosure.

FIG. 5A is a conceptual diagram depicting the structure of a multi-layer network architecture, according to some embodiments of this disclosure.

FIG. 5B is a diagram illustrating a sending layer table that maps each host ID to the layers they use for sending data flows, according to some embodiments of this disclosure.

FIG. 5C is a diagram illustrating a receiving layer table that maps each host ID to the layers they use for receiving data flows, according to some embodiments of this disclosure.

FIG. 6 is a schematic diagram of a three-tier network topology with leaf switches, spine switches, and core switches, according to some embodiments of this disclosure.

FIG. 7 is a schematic diagram of an unfolded version of the three-tier topology shown in FIG. 6, with spine and core switches grouped into distinct color-coded blocks.

FIG. 8A is an example coordinator allocation table used in the first step of a three-tier looping-based load balancing algorithm, according to some embodiments of this disclosure.

FIGS. 8B and 8C are example coordinator allocation tables used in the second step of the three-tier looping-based load balancing algorithm, according to some embodiments of this disclosure.

FIG. 9 is an alternative coordinator allocation table for managing data flows within a centralized solution for a three-tier network topology, according to some embodiments of this disclosure.

FIG. 10A is a schematic diagram of a network topology incorporating multiple links between leaf and spine switches, according to some embodiments of this disclosure.

FIG. 10B is a diagram providing a detailed view of a specific scenario within a multi-link leaf-spine topology, according to some embodiments of this disclosure.

FIG. 10C is a diagram illustrating the multi-link leaf-spine topology, detailing how link indexes are assigned between leaf switches and the spine switch, according to some embodiments of this disclosure.

FIG. 10D is an example coordinator allocation table used in a multi-link leaf-spine topology, according to some embodiments of this disclosure.

### DETAILED DESCRIPTION

Load balancing (LB) has long been recognized as a useful component in various data networks, including data center networks (DCNs). LB techniques are employed to distribute traffic flows evenly across different network paths, thereby enhancing network utilization. The use of LB in such networks may contribute to higher performance, improved scalability, robustness, and better energy efficiency, making it a useful element in the management of data traffic within these environments.

Various LB mechanisms have been proposed to optimize traffic distribution. Some approaches split traffic at the switch level using flowlets, which are small bursts of packets within a flow that are separated by brief idle periods, to minimize packet re-ordering, while others assign flowlets to paths based on real-time congestion feedback from remote switches. These distributed mechanisms typically rely on the burstiness of traffic and make LB decisions when flowlets emerge, which can be challenging for non-bursty flows.

Centralized LB mechanisms may use dynamic flow scheduling to manage multi-stage switch topologies or maximize network throughput. These methods may collect flow information to compute paths and balance workloads dynamically. However, they often depend on heuristic algorithms that may not guarantee optimal flow allocation. Other LB solutions address data center uncertainties by detecting path failures and rerouting traffic using transport-level signals and active probing. However, such solutions may require modifications at the end-hosts, making them host-based.

In network environments, data flows can generally be categorized into two types: elephant flows and mice flows. Elephant flows refer to large, long-duration data transfers that consume significant bandwidth, often contributing disproportionately to network congestion. Mice flows, on the other hand, are small, short-duration transfers that individually have minimal impact on network performance. It may be advantageous if LB mechanisms can identify and differentiate between these flow types to optimize network performance. Mice flows are often sensitive to latency and packet reordering, while elephant flows require efficient handling to prevent bottlenecks and maintain high throughput across the network.

In distributed machine learning environments, elephant flows are particularly common and present unique challenges due to their large size, low entropy, and synchronized communication patterns. These characteristics necessitate specialized LB mechanisms that can effectively manage the high throughput demands of elephant flows while ensuring efficient data processing and minimizing network congestion. Properly differentiating and handling elephant and mice flows is critical to optimizing the overall performance of the network.

The present disclosure introduces an in-network coordinated load balancing (CLB) mechanism that is specifically designed to meet requirements of distributed machine learning (DML) traffic. This centralized CLB scheme differentiates between mice and elephant flows, applying stochastic load balancing techniques, such as ECMP or Hop-by-hop Utilization-aware Load balancing Architecture (HULA), for mice flows, while utilizing the deterministic loop algorithm for elephant flows. The loop algorithm is involved to solve the allocation problem optimally for elephant flows, ensuring efficient and balanced distribution across the network.

Central to the CLB mechanism is the role of a centralized node, referred to as the “coordinator,” which is responsible for executing the loop algorithm, described below. One of the network switches can be assigned this role, enabling centralized control over the load balancing process. To manage memory effectively, aging mechanisms are implemented within the coordinator to clear its memory once the elephant flows have concluded. Additionally, the present disclosure leverages the repetitive nature of DML traffic by equipping leaf switches with a memory feature that remembers the optimal allocations previously assigned by the coordinator. This memory feature minimizes communication between top-of-rack (ToR) switches and the coordinator, enhancing the efficiency of the system.

The present disclosure also demonstrates the adaptability of the loop algorithm to various network configurations, including its application in two-tier, three-tier, or more-than-three-tier networks. In network architecture, a “tier” refers to a level of hierarchical structure in the network design, which may include different types of switches and routers that manage traffic flow. For example, a two-tier architecture may include a number of leaf switches (often referred to as access switches) that connect directly to spine switches (aggregation switches) responsible for routing data between the leaf switches. A three-tier architecture adds another level, introducing core switches that manage traffic between multiple sets of spine switches, allowing the network to scale further by segmenting traffic across multiple aggregation points.

In network architecture, a leaf switch refers to a switch located at the first tier, connecting directly to end devices such as servers. It aggregates local traffic and forwards it to higher-tier switches. A spine switch operates at the second tier, interconnecting multiple leaf switches and routing traffic therebetween. In a larger network such as a three-tier network, a core switch is introduced at the third tier to handle traffic between different spine switches.

Furthermore, the loop algorithm has been modified to function effectively in networks with multi-link connections, where multiple physical connections exist between components, and in scenarios where multiple flows are simultaneously traversing the network. These enhancements ensure that the CLB mechanism can operate efficiently across a wide range of network infrastructures for modern data centers and distributed machine learning environments.

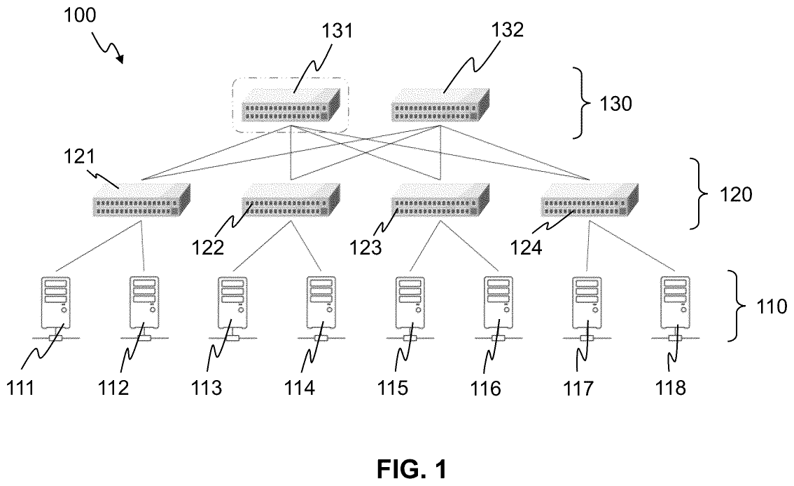

FIG. 1 illustrates a network system 100 implementing a two-tier single-link leaf-spine topology that may be used in data center networks. The network system 100 comprises a plurality of server nodes 110, a first tier 120 of switches, and a second tier 130 of switches.

The server nodes 110, identified as nodes 111 through 118, are computational devices that serve as endpoints for data exchange within the network. Each server node is responsible for generating, processing, and receiving data flows for the overall operation of the network system 100. These server nodes are connected to the first tier 120 of switches, which comprises a plurality of leaf switches 121, 122, 123, and 124. A leaf switch is a network device that acts as the primary interface between the server nodes and the higher-tier switches in the network architecture. Each leaf switch receives data flows from the connected server nodes and determines the appropriate path for these data flows, facilitating their transmission through the network.

The leaf switches 121-124 are, in turn, connected to the second tier 130 of switches, which comprises a first spine switch 131 and a second spine switch 132. A spine switch functions as the backbone of the network's routing infrastructure, connecting the various leaf switches and facilitating the high-speed transfer of data between them. In this example, each of the leaf switches 121-124 is connected to two of the nodes and to both the first spine switch 131 and the second spine switch 132. This configuration allows for multiple data paths, which may enhance the network's fault tolerance and load distribution capabilities. It should be understood that, in this particular example, the route for a data flow includes one of the spine switches.

In this embodiment, one of the spine switches, such as the first spine switch 131, is designated as the centralized coordinator. This designated coordinator, referred to herein as the “coordinator,” as encircled by dashed lines in FIG. 1, plays a role in managing the load balancing across the network system 100. Load balancing (LB) is a method used to distribute data flows evenly across the network paths to optimize utilization, prevent congestion, and maximize overall system throughput. The coordinator achieves this by gathering information about the data flows within the network and providing link assignments to the designated switches. This centralized approach ensures that all network components operate in a coordinated manner, thereby optimizing traffic flow and preventing bottlenecks.

For example, when a source server node 111 initiates a data flow intended for a destination server node 116, the data flow containing a sequence of data packets is transmitted to the associated source leaf switch 121. A data packet is the fundamental unit of data transfer within the network, comprising a payload (the actual data being transmitted) and metadata. Metadata may include routing information such as source and destination IP addresses, source and destination port numbers, and the protocol, which are used for directing the packet through the network. Collectively, these elements are often referred to as the five-tuple, a set of parameters that uniquely identifies each data flow within the network. The source leaf switch 121 may comprise a packet receiver for receiving the data flow or data packets, a leaf storage unit in which a forwarding table is stored, and a leaf control unit. The forwarding table is a data structure that contains information about available routes for the flow of data packets, enabling the leaf switch to determine the correct path for forwarding the data flow if the forwarding table contains a route for it. The leaf control unit is adapted to determine whether a route for the data flow exists in the forwarding table using the routing metadata obtained from at least one of the data packets. If the intended route exists, the data flow can be directly routed to the destination leaf switch according to the intended route. If the intended route does not exist, the leaf control unit generates a control packet. A control packet is a specialized packet that is used to request routing information or other control data from another network device, in this case, the coordinator (the first spine switch 131).

The coordinator, comprising a coordinator storage unit in which an allocation table is stored and a coordinator control unit, processes the control packet by modifying the allocation table, such as using a loop algorithm. The allocation table is a data structure that records the routing paths and link assignments for data flows within the entire network, allowing the coordinator to optimize these paths dynamically. The loop algorithm is a deterministic method employed by the coordinator to solve the allocation problem and find optimal routes for the data flow, considering current network conditions and traffic loads to avoid collisions. For example, the loop algorithm iteratively examines each possible route for the data flow, searching for available links between the source and destination nodes. It selects a path that does not conflict with existing data flows by adjusting assignments within the allocation table and, if needed, reassigning other flows to different paths to avoid congestion. The modified allocation table includes an optimized route for the data flow. The coordinator then transmits the updated route back to the source leaf switch 121. The leaf control unit of the source leaf switch 121 is further adapted to update the forwarding table using the updated route and to transmit the data flow to the destination node 116 according to the updated allocation table. In this example, the forwarding table will be updated to record that the data packet will follow a route from the source leaf switch 121 to the leaf switch 123 through either the first spine switch 131 or the second spine switch 132, and eventually reach the destination server node 116.

This centralized load balancing mechanism enables the leaf switches 121-124 to coordinate with the coordinator (the first spine switch 131) to make optimized forwarding decisions, thereby maximizing total system throughput and avoiding flow collisions within the network system 100. By efficiently managing data flows and routing paths, the CLB mechanism according to the embodiments described herein ensures that the network operates at peak efficiency, even under heavy traffic conditions.

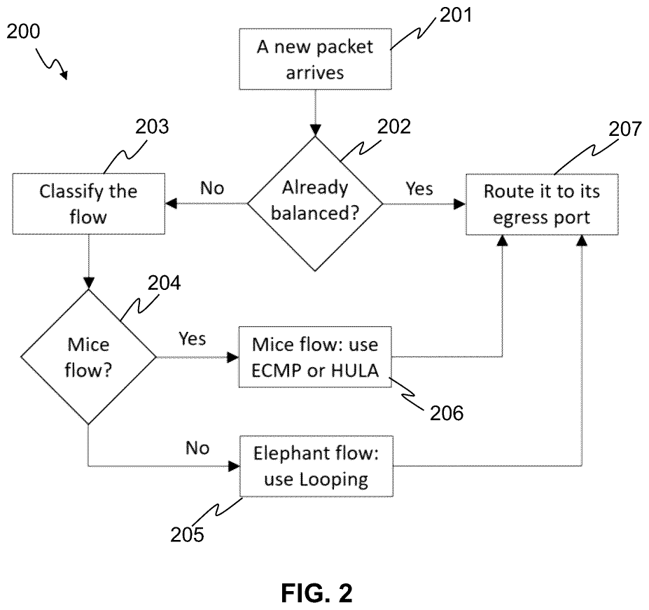

FIG. 2 illustrates an example flowchart 200 summarizing the overall operation of the CLB mechanism according to the embodiments described herein within a DCN. The process begins at operation 201, where a new data packet of a data flow arrives at the network. Upon the arrival of the data packet, the system first determines, at operation 202, whether the data flow to which the data packet belongs is already balanced. This determination can be performed by examining the forwarding table or other relevant metrics to assess whether the load distribution for the flow has already been optimized. If the flow is already balanced, the data packet is routed directly to its designated egress port at operation 207, completing the process.

In the context of the present invention, a “data flow” refers to a sequence of data packets sharing the same source and destination IP addresses, port numbers, and protocol, collectively known as the five-tuple. Each data packet is a unit of transfer containing part of the overall data and its associated metadata. While a data packet represents a single piece of data being transmitted, a data flow encompasses the entire communication session between a source and destination.

If the flow is not already balanced, the process proceeds to operation 203, where the data flow is classified to determine its type. This classification may occur at the leaf switches. During this operation, the system analyzes the flow characteristics, such as its size and duration, to classify the data flow as either a mice flow or an elephant flow.

At operation 204, the system checks whether the data flow is a mice flow. Mice flows are typically smaller, short-duration flows that require different handling compared to larger flows. If the flow is identified as a mice flow, the system proceeds to operation 206, where the data flow is routed using a stochastic load balancing method such as ECMP or HULA. These methods are designed to efficiently distribute mice flows across available network paths, minimizing latency and optimizing network resource utilization.

If the flow is not classified as a mice flow, it is identified as an elephant flow, a larger, long-duration flow that demands more careful management to prevent network congestion. The system then proceeds to operation 205, where the loop algorithm may be employed to route the data flow. As described above, the loop algorithm is a deterministic method used to ensure that elephant flows are distributed optimally across the network, avoiding potential bottlenecks and ensuring that the network operates at peak efficiency.

After either the ECMP/HULA or loop algorithm routing is applied, the data flow is routed to its appropriate egress port at operation 207, concluding the process. This operation ensures that the data flow reaches its intended destination through an optimized path, based on the flow classification and the applied load balancing technique.

The classification of data flows and the corresponding routing operations can be performed by the leaf switches. This flowchart 200 illustrates the dynamic decision-making process used by the CLB mechanism to efficiently manage both mice and elephant flows within the network, ensuring that each type of flow is handled according to its specific characteristics to maintain overall network performance and stability.

### Embodiment 1: CLB Framework for Mice and Elephant Flows

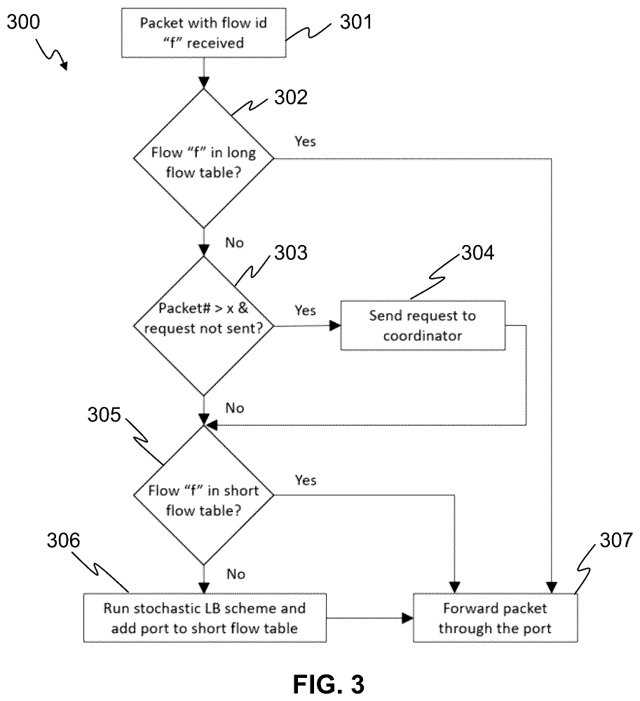

FIG. 3 illustrates a flowchart 300 that outlines the sequence of operations performed by a leaf switch when a data packet belonging to a flow “f” arrives at the switch. The operations shown in FIG. 3 are part of the CLB framework described in Embodiment 1, which is implemented within the two-tier network architecture depicted in FIG. 1.

Upon receiving a packet with flow ID “f” at operation 301, the leaf switch first checks whether the flow “f” is recorded in its long flow table at decision operation 302. The long flow table is specifically used to store forwarding information for elephant flows, which are large, long-duration flows that have been assigned by the centralized coordinator (as described in FIG. 1). The long flow table may be part of the forwarding table. If the flow “f” is found in the long flow table, the leaf switch forwards the data flow using the port specified in the table, thereby ensuring that the data flow follows the optimal path previously determined by the coordinator.

If the flow “f” is not found in the long flow table, the leaf switch proceeds to decision operation 303 to determine whether the flow “f” has met the criteria for being considered an elephant flow. In this embodiment, the criterion used is whether the number of packets forwarded for flow “f” has exceeded a predefined threshold “x.” Additionally, the leaf switch checks whether a request (control packet) has already been sent to the coordinator. If the threshold has been exceeded and no request has yet been sent, the leaf switch sends a request to the coordinator at operation 304. The coordinator will then use the loop algorithm to assign a path for the elephant flow, and the long flow table will be updated accordingly.

If the flow “f” has not met the criterion for classification as an elephant flow, the leaf switch moves on to decision operation 305 to check the short flow table. The short flow table is used for forwarding information related to mice flows, which are smaller, short-duration flows. The short flow table may also be part of the forwarding table. If an entry for flow “f” is found in the short flow table, the data flow is forwarded using the corresponding port, as indicated by operation 307.

If the flow “f” is not found in the short flow table, indicating that it is a new flow, the leaf switch proceeds to operation 306. Here, the leaf switch runs a stochastic load balancing (LB) scheme, such as ECMP or HULA, to determine the optimal port for forwarding the mice flow. After determining the port, the leaf switch adds an entry for flow “f” in the short flow table, ensuring that subsequent packets belonging to this flow are forwarded consistently through the same port.

The sequence of operations depicted in FIG. 3 allows the leaf switch to efficiently manage both mice and elephant flows, ensuring that each type of flow is routed according to its specific characteristics and the overall load balancing strategy of the network. By maintaining separate forwarding tables for mice and elephant flows, the leaf switch can quickly determine the appropriate action for each packet, minimizing delays and optimizing network performance within the architecture such as described in FIG. 1.

However, it should be understood that the determination of whether a flow is classified as a mice flow or an elephant flow is optional. This classification may be unnecessary in scenarios where the flow type is predetermined, such as when all flows are known to be elephant flows. In such cases, the system can bypass the classification step and proceed directly with the appropriate load balancing and routing mechanisms designed for elephant flows.

In response to detecting that the flow is an elephant flow, such as at operation 303 or 304, the leaf switch initiates a sequence of operations to manage and optimize the routing of this flow. The procedure can be summarized in the following:
The leaf switch determines that the flow “f” qualifies as an elephant flow. This determination is made based on criteria such as the number of packets forwarded for the flow exceeding a predefined threshold, as described earlier in operation 303 of FIG. 3.
Once the flow is classified as an elephant flow, the leaf switch sends a request (control packet) to the centralized coordinator (one of the spine switches in FIG. 1) for load balancing instructions. While awaiting a response, the leaf switch may continue to forward the packets of flow “f” using the existing egress port. This ensures that there is no interruption in the data transmission while the optimal routing path is being determined by the coordinator.
Upon receiving the request, the coordinator executes the loop algorithm employed for load balancing elephant flows. The loop algorithm processes the flow information and determines the most suitable path for flow “f” by identifying the appropriate spine switch to handle the flow. The coordinator then sends the identifier of this spine switch (“spine ID”) back to the requesting (source) leaf switch.
Upon receiving the spine ID from the coordinator, the leaf switch may map the returned spine ID to a local egress port. The leaf switch then updates its long flow forwarding table with this information, ensuring that all subsequent packets belonging to flow “f” are forwarded through the designated egress port. This mapping allows the leaf switch to efficiently route the packets of flow “f” along the path determined by the loop algorithm, optimizing network performance and avoiding potential congestion.
The packets of flow “f” are then transmitted through the network and reach the destination leaf switch. The destination leaf switch receives the packets and forwards them according to the routing information stored in its own forwarding table.
Finally, the packets of flow “f” arrive at the destination node. The node processes the incoming data, completing the transmission of the flow. Throughout this process, the CLB mechanism ensures that the elephant flow is handled efficiently, maintaining high throughput and minimizing delays within the network.

This sequence of operations highlights the coordinated effort between the leaf switches and the centralized coordinator to manage and route elephant flows effectively. The Looping request-response mechanism between the leaf switch and the centralized coordinator can be summarized in the following. This mechanism outlines the interaction between the leaf switch and the coordinator when managing elephant flows within the network. The following steps describe this process:
For each identified elephant flow, the leaf switch initiates a request message (control packet) to the coordinator. This request is essential for the centralized load balancing process.
The request message includes the flow ID (f_id), which uniquely identifies the flow within the network.
Upon receiving the request, the coordinator stores these requests in a queue and processes them in the order they are received. This queued processing ensures that each flow is addressed systematically without causing disruptions in the network.
After processing, the coordinator initiates a response message (control packet) to the associated leaf switch for all routes that have been changed or updated as a result of running the loop algorithm.
The response message includes the flow ID (f_id) and the assigned spine switch identifier (spine ID), indicating the spine switch to which the flow should be directed for optimal routing.

The coordinator acts as the centralized decision-making unit responsible for executing the loop algorithm and selecting the optimal path for each new elephant flow. The loop algorithm is detailed below and is performed by the coordinator upon receiving a request from a leaf switch.

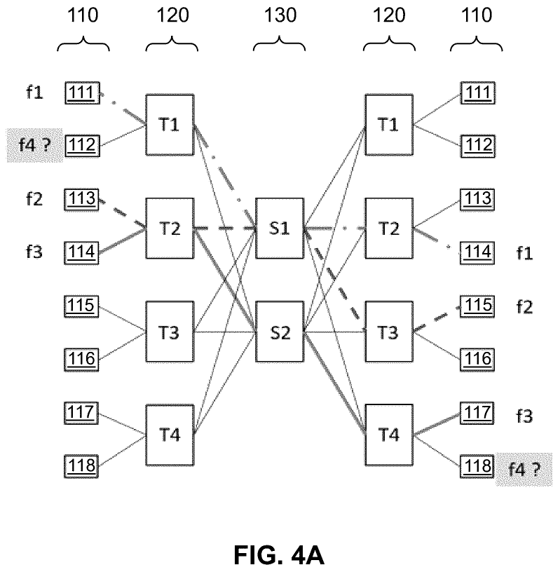

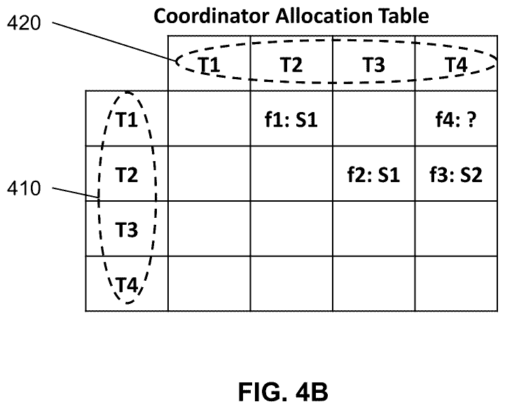

Upon receiving each request message (as described above), the coordinator performs the following steps, as outlined in the loop algorithm:
The coordinator first identifies the associated row and column in its allocation table (an example of which is illustrated in FIG. 4B). The allocation table is a data structure used by the coordinator to track and assign spine switches for various flows in the network.
If the coordinator finds a spine ID that is not already present in the row or column, it assigns this spine ID to the flow and updates the table cell accordingly. This assignment ensures that the flow is routed through an available and optimal spine switch, thereby balancing the load across the network.
If no such spine ID is available, the coordinator seeks a more complex solution. It identifies a spine ID “c” that is in the same row but not in the column, and another spine ID “d” that is in the same column but not in the same row. The coordinator then assigns “d” to the current entry and replaces “d” in the column with “c.” If a spine ID “c” exists in the same row, the algorithm replaces it with “d” and continues recursively, following the loop algorithm until an appropriate assignment is made.

The loop algorithm employed by the coordinator is highly efficient, with a complexity that can be expressed as (2*ToR #−2), where ToR #represents the number of Top-of-Rack (ToR) switches in the network. This complexity can be further optimized to (ToR #−1), ensuring that the algorithm performs effectively even in large-scale networks.

By employing this loop algorithm, the coordinator ensures that each elephant flow is routed through the most appropriate spine switch, maintaining network balance and preventing congestion. The systematic and recursive nature of the algorithm allows it to adapt to changing network conditions, ensuring that the load balancing decisions remain optimal over time.

FIGS. 4A and 4B collectively illustrate the operation of a two-tier unfolded leaf-spine topology with four leaf switches (T1, T2, T3, and T4) and two spine switches (S1 and S2). In this configuration, spine switch S1 serves as the centralized coordinator responsible for managing the allocation of elephant flows within the network.

FIG. 4A depicts the network topology, where the server nodes 110 are connected to the leaf switches 120, and these leaf switches are interconnected with the spine switches 130. The flows f1, f2, f3, and f4 represent different data flows between various source and destination pairs of ToR switches, which correspond to the leaf switches. As each flow is initiated, a request is sent to the coordinator S1 to determine the appropriate spine switch for routing the flow. It is noted in FIG. 4A that the ToR switches and the nodes on the right-hand side are merely duplicates of those on the left-hand side. This duplication is presented to better illustrate and capture the flow of data between the corresponding components in the network.

FIG. 4B illustrates the coordinator allocation table, which is stored in and used by the coordinator to track and manage the allocation of flows to spine switches. The table is organized with the source ToR switches represented by the leftmost column 410 and the destination ToR switches represented by the topmost row 420. Each cell in the table indicates the spine switch assigned to handle the flow between the corresponding source and destination ToR switches.

The process begins with the allocation of flow f1, which originates from T1 and is destined for T2. As shown in FIG. 4B, when the coordinator receives the request for f1, it checks the row corresponding to T1 and the column corresponding to T2. Since all spine switches are initially available, the coordinator assigns spine switch S1 to handle flow f1, and this allocation (f1: S1) is recorded in the appropriate cell of the coordinator allocation table. The result is then communicated to the source leaf switch T1.

Next, a request for flow f2 is processed, which originates from T2 and is destined for T3. Similarly, the coordinator checks the row for T2 and the column for T3, finding that all spine switches are still available for this flow. Consequently, spine switch S1 is again assigned to flow f2, and this information (f2: S1) is updated in the allocation table and sent to T2.

The process continues with flow f3, which originates from T2 and is destined for T4. At this stage, the coordinator observes that spine switch S1 is already assigned to handle flow f2 from T2 to T3. As a result, spine switch S2 is assigned to flow f3 to ensure an even distribution of traffic and avoid potential congestion. This assignment (f3: S2) is reflected in the corresponding cell in the allocation table.

Finally, a request arrives for flow f4, which originates from T1 and is destined for T4. Upon examining the allocation table, the coordinator identifies a conflict: spine switch S1 is already allocated to flow f1 in the row of T1, and spine switch S2 is allocated to flow f3 in the column of T4. To accommodate flow f4, the coordinator needs to perform a readjustment of the existing allocations. The solution involves reassigning flow f3 to spine switch S1 and flow f2 to spine switch S2. With these adjustments, spine switch S2 can then be assigned to flow f4, ensuring that all flows are routed efficiently without causing congestion.

It is noted that the loop algorithm described above is specifically applied to elephant flows, which are less sensitive to latency. This design choice allows the coordinator to perform these adjustments without significantly impacting network performance. Although changing the path of a flow may introduce some out-of-order packets, this issue is mitigated by the fact that elephant flows can tolerate a certain degree of out-of-order delivery. The overall benefit of avoiding flow collisions through the loop algorithm outweighs the potential drawbacks of packet reordering, as demonstrated by simulations. It should also be understood that other approaches than the loop algorithms may be used, such as machine learning-based prediction models for routing decisions.

In addition to the process of allocating new flows, it may be advantageous to manage the lifespan of these data flows within the network to optimize resource usage and ensure efficient data transmission. The present disclosure may employ an aging mechanism to handle the completion of elephant flows. An elephant flow is considered finished if its sender does not transmit any packets for a predefined period, known as the Flow Timeout (FTO). Even if the connection remains technically alive, the absence of packet transmission within this period prompts the system to mark the flow as finished. The ToR switches periodically check all active elephant flows to determine if any packets have been received within the FTO period. If no packets are received, the flow is deemed finished, prompting the ToR switch to send a “looping remove” message to the coordinator. Upon receiving this message, the coordinator can remove information on the flow from its allocation table, freeing up resources for future routing tasks.

It may be advantageous to implement memory-based routing, which reduces the need for continuous communication between the ToR switches and the coordinator. If a flow has been previously routed by the coordinator and the same flow is detected again, the ToR switch can use the previously determined routing decision. This memory-based technique leverages the repetitive nature of communication patterns to minimize the exchange of control messages, thereby reducing network overhead. To maintain optimal routing, the ToR may still inform the coordinator of the used port (spine ID). The coordinator then verifies whether this port aligns with the current network traffic conditions. If not, the coordinator re-executes the loop algorithm and sends an updated port to the ToR switch, which updates its routing accordingly.

The CLB mechanism may also support both online and offline modes of operation to accommodate different network management needs. In the online mode, flows are processed in real-time, with looping requests and responses dynamically exchanged between the ToR switches and the coordinator. This allows for real-time load balancing adjustments based on current network conditions. Alternatively, in the offline mode, the coordinator is provided with the traffic flow information in advance, allowing it to run the loop algorithm and populate the ToR switches' forwarding tables before the actual flows begin. This preemptive approach can help prevent out-of-order delivery issues, provided the communication patterns are known beforehand. Both modes of operation offer flexibility in managing network resources and ensuring optimal performance based on specific network requirements.

### Embodiment 2: Multi-Flows Per Path

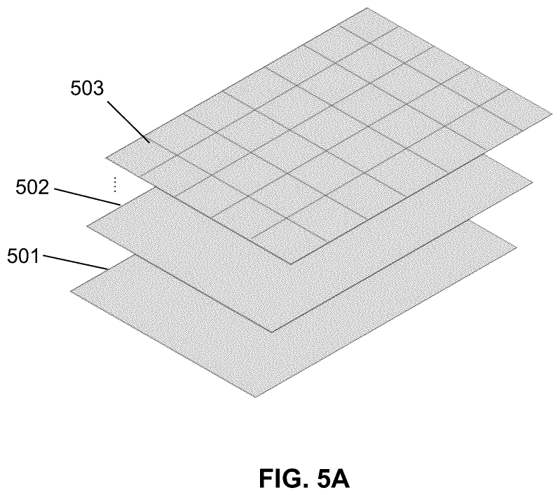

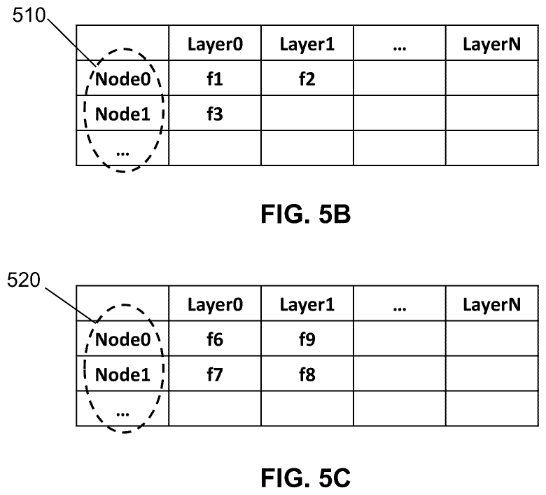

FIGS. 5A-5C collectively illustrate an extended approach for managing multiple flows per path in a multi-tier network architecture. This approach introduces the concept of layers, where each layer represents an independent routing instance that allows simultaneous data transmission via the same route on different layers. These layers may be virtual layers that optimize the use of network resources and allow for running the loop algorithm for each layer independently to minimize flow collisions.

FIG. 5A depicts the conceptual structure of the multi-layer network architecture. In this embodiment, the coordinator allocation table is expanded into a three-dimensional model, where each layer represents a distinct instance of the allocation table (similar to that shown in FIG. 4B). Each of layers 501, 502, and 503 is an independent representation in which the loop algorithm can run to determine the routing of data flows. When a new round of flows is introduced while previous flows still exist, these new flows can occupy the next available layer. This layered approach allows the loop algorithm to be applied independently for each layer, effectively managing multiple flows that may share the same physical path.

FIG. 5B shows a sending layer table 510, which maps each host ID to the layers they use for sending data flows. This table tracks the allocation of flows sent by each node (i.e., each node on the left-hand side as shown in FIG. 4A) across different layers. For instance, in this example, Node0 is sending flow f1 on Layer0 and flow f2 on Layer1, while Node1 is sending flow f3 on Layer0.

FIG. 5C illustrates a receiving layer table 520, which similarly maps each host ID to the layers they use for receiving data flows. This table helps coordinate the layers used by each node to receive data flows (i.e., each node on the right-hand side as shown in FIG. 4A), ensuring that multiple flows can be managed without interference. In the example provided, Node0 is receiving flow f6 on Layer0 and flow f9 on Layer1, while Node1 is receiving flows f7 and f8 on Layer0 and Layer1, respectively.

The use of these three tables—the sending layer table, the receiving layer table, and the multi-dimensional coordinator allocation table (which can be a number of allocation tables as shown in FIG. 4B)—enables the efficient handling of multiple concurrent flows. When a new request message arrives, the coordinator follows a series of steps to allocate the flow to the appropriate layer. First, it identifies the source and destination hosts based on the flow ID. It then determines the smallest available layer number that is free at both the source and destination hosts by checking the sending layer table and receiving layer table. If no such layer exists, a new layer is created. Finally, the coordinator applies the loop algorithm such as from Embodiment 1 to the new flow and the selected layer.

For example, as shown in FIGS. 5B and 5C, if a node with HostID “Node1” needs to send a new flow “f5” to another node with HostID “Node0”, the coordinator would select “Layer2” as the appropriate layer. This selection is based on the fact that the first available layer in the sending layer table for Node1 is “Layer1”, while the first available layer in the receiving layer table for Node0 is “Layer2”. Therefore, “Layer2” is chosen for consistency across both tables. In practical implementations, a maximum number of layers can be predefined. If the number of simultaneous flows exceeds this maximum, a default load balancing mechanism, such as ECMP or HULA, may be applied to manage the new flow.

### Embodiment 3: Three-Tier Topology

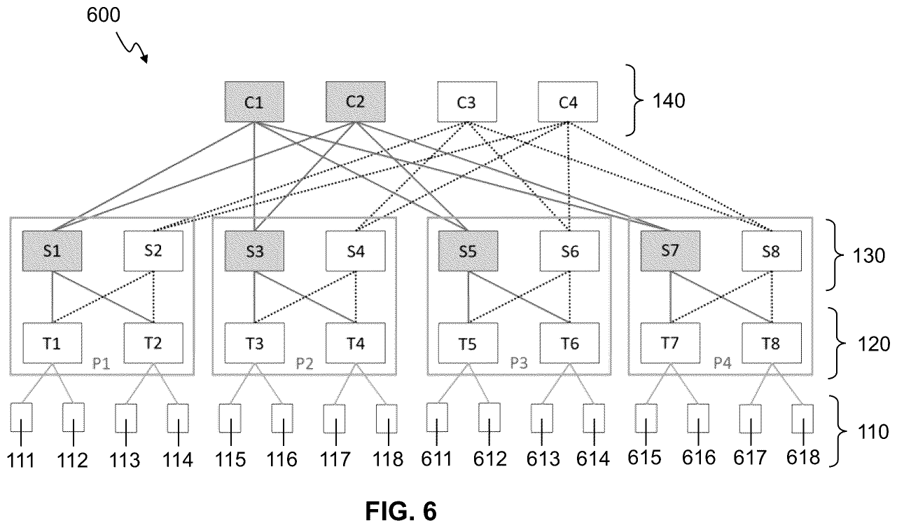

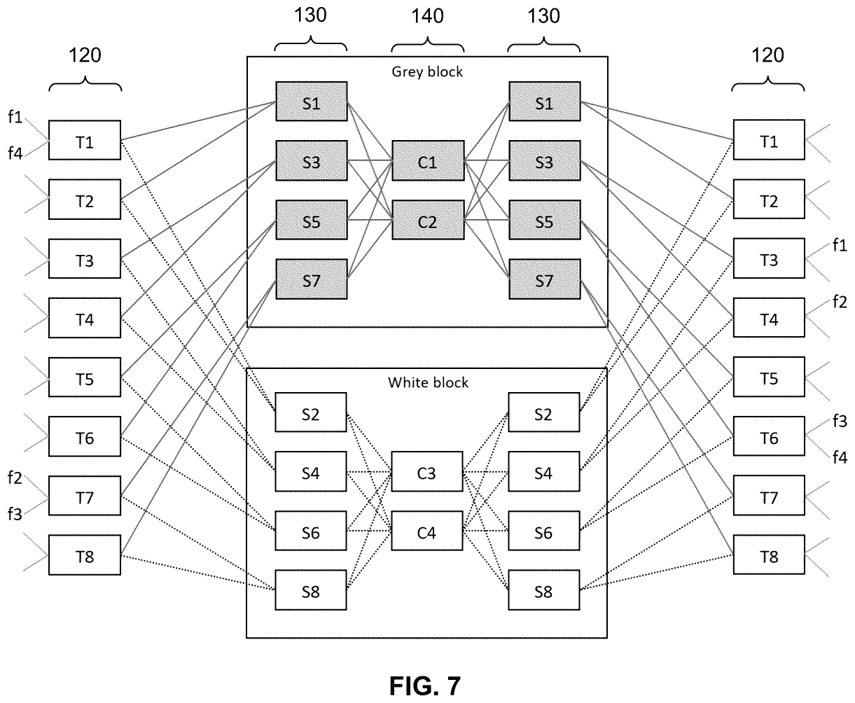

FIGS. 6 and 7 collectively illustrate a three-tier network topology utilized for implementing a CLB mechanism within a data center network. The network architecture comprises three tiers: a first tier of leaf switches (ToR switches), a second tier of spine switches (aggregation switches), and a third tier of core switches.

FIG. 6 shows the three-tier topology 600 with leaf switches 120, spine switches 130, and core switches 140. Among server nodes 110, a number of nodes 111-118 and 611-618 are connected to their respective leaf (ToR) switches T1-T8. In this topology, each switch is designed with four ports (K=4). The ToR switches (T1-T8) and spine switches (S1-S8) are organized into four distinct pods, labeled P1, P2, P3, and P4. Each pod comprises a set of ToR switches connected to spine switches, with each ToR switch connected to two spine switches, as shown in FIG. 6. The core switches (C1, C2, C3, and C4) form the third tier, providing a higher level of aggregation and routing between the spine switches. One of the core switches may be set as the coordinator. This hierarchical structure allows for efficient routing and load balancing across multiple paths, ensuring high availability and redundancy.

FIG. 7 illustrates the unfolded version of the three-tier topology shown in FIG. 6. In this unfolded view, the spine and core switches are grouped into two distinct color-coded blocks: Grey block and White block. Each block represents a different combination of spine and core switches, forming a path between the source and destination ToR switches. This configuration illustrates how the load balancing decision is made in a two-step process.

The first step in managing data flows within the multi-tier network involves selecting the appropriate group, or block (color), for each flow. The network is structured such that a first number of spine switches and a first number of core switches are grouped into a first group, while a second number of spine switches and a second number of core switches are grouped into a second group. Each group contains a set of spine and core switches that work together to manage traffic within that segment of the network. In this figure, we have two types of coordinators: first-stage and second stage coordinators. For example, C1 can act as a first-stage coordinator whose role is to determine which group (block) a particular flow should use based on current load and the availability of resources within each group, as well as the specific requirements of the elephant flow being routed. Moreover, a core switch in each group acts as a second-stage coordinator. For example, C1 serves as the second-stage centralized coordinator switch for the first group (Grey block), and C3 serves as the second-stage centralized coordinator switch for the second group (White block).

Once the appropriate group (block) is selected, the second step (performed by the second-stage coordinators) involves choosing a specific path within the chosen group. The second-stage coordinators (e.g., C1 in the Grey block and C3 in the White block) are responsible for distributing flows from the spine switches to the core switches within their respective groups. This process ensures that flows are evenly distributed across available paths within each group, thereby minimizing congestion and optimizing network performance.

To facilitate this process, the control packet used in the network may be divided into two parts: a first control packet and a second control packet. The first control packet is transmitted to the centralized coordinator switch (e.g., C1) to determine whether the data flow should be routed through the first group (Grey block) or the second group (White block). This decision is based on real-time assessments of network conditions and load distribution. After the appropriate group is determined, the second control packet is transmitted to either the centralized coordinator switch (C1) or the second coordinator switch (C3), depending on the group selected, to determine the specific core switch within that group that should be used for the data flow. This ensures that the routing paths are optimized based on current network dynamics.

The loop algorithm, as described in Embodiment 1, may be employed in both stages to identify the most efficient routing paths. In the first stage, the algorithm determines which group (block) should handle the flow. In the second stage, it selects the specific path within the chosen group. This dual-layer approach ensures that load is balanced effectively across the entire network, leveraging the multi-tier topology and the adaptability provided by the different color-coded blocks.

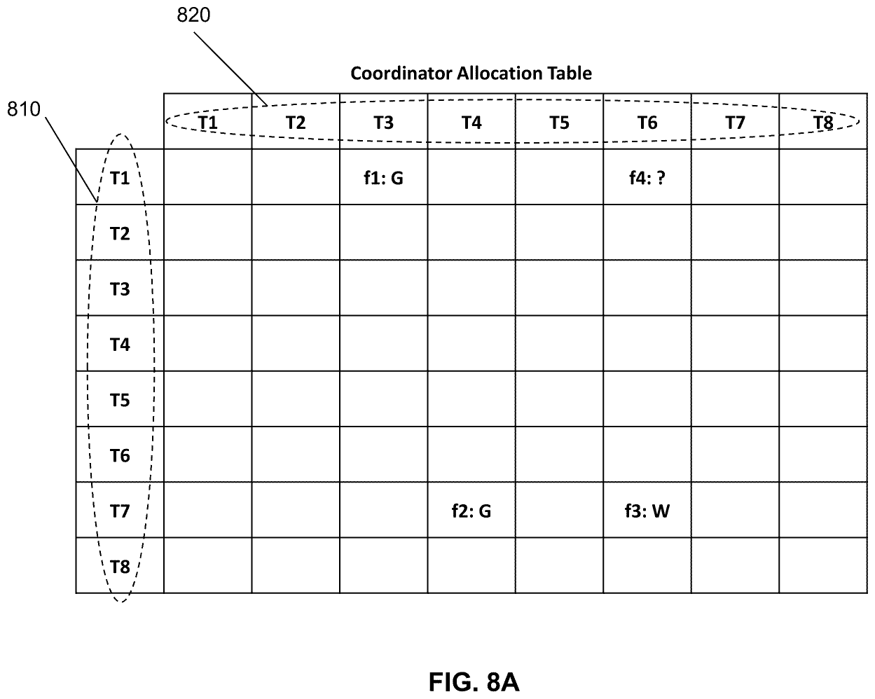

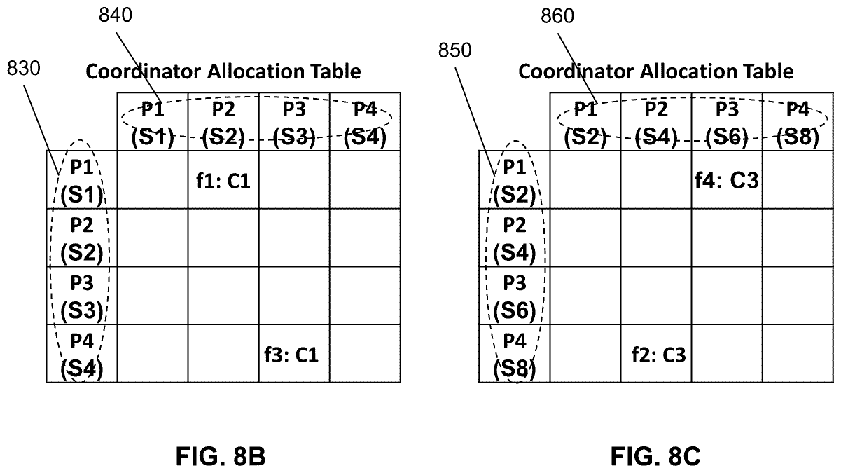

FIGS. 8A-8C collectively illustrate the data structures used in the two-step process of the three-tier looping-based LB algorithm in a network architecture. The algorithm ensures efficient routing of data flows by determining optimal paths through a multi-tier network.

FIG. 8A represents the data structure used in the first step of the three-tier looping-based LB algorithm. This table is stored in the first-stage coordinator, which in this example is core switch C1. As described above, the first step involves selecting an appropriate color-coded block (Grey or White) for each flow. The table in FIG. 8A shows a column of source ToR switches 810, denoted as T1 through T8, and a row of destination ToR switches 820, also labeled T1 through T8. Each cell in the table indicates whether a flow is assigned to the Grey block (“G”) or the White block (“W”).

In this example, there are K/2 available ports for paths between ToR switches and spine switches, corresponding to the two colors: Grey and White. The first-stage coordinator, C1, chooses one of these ports, effectively selecting a spine switch or a color group. As depicted in FIG. 8A, flow f1 is assigned to the Grey block. Similarly, flow f2 is assigned to the Grey block. Flow f3, however, cannot be assigned to the Grey block due to a conflict with flow f2 at the receiving ToR (T3), and thus is assigned to the White block. When flow f4 arrives, conflicts arise with f1 at the transmitting TOR (T1) and with f3 at the receiving ToR (T6). The loop algorithm may then be activated, which iteratively adjusts the allocations: f4 is assigned to the White block, f3 to the Grey block, and f2 to the White block. This iterative process ensures that each block is used efficiently without conflicts in either the transmitting or receiving directions.

FIGS. 8B and 8C illustrate the data structures used in the second step of the three-tier looping-based LB algorithm. In this step, the second-stage coordinators determine the specific paths that flows will take within the selected blocks (Grey or White). FIG. 8B shows the table stored in the second-stage coordinator C1 for flows assigned to the Grey block, while FIG. 8C displays the table stored in the second-stage coordinator C3 for flows assigned to the White block.

The tables in FIGS. 8B and 8C are organized such that the columns 830, 850 represent source spine switches (S1, S3, S5 and S7 for the Grey block; S2, S4, S6, and S8 for the White block), and the rows 840, 860 represent destination spine switches (S1, S3, S5 and S7 for the Grey block; S2, S4, S6, and S8 for the White block). Each entry in the tables indicates the specific core switch that a flow will use within the selected color group. For example, in FIG. 8B, flow f1 is routed through core switch C1, and flow f3 also uses core switch C1 but for a different pair of source and destination spine switches, avoiding any conflicts. Similarly, FIG. 8C shows the allocation for flows in the White block; for instance, flow f2 is routed through core switch C3, and flow f4 through core switch C3 but on different paths.

Each table in FIGS. 8B and 8C ensures that a specific core switch appears only once per row and column, maintaining unique paths for each flow to prevent congestion and maximize network performance. The results from the first-step allocation (FIG. 8A) may be stored on the source ToR, while the results from the second-step allocation (FIGS. 8B and 8C) may be stored on the first spine switch encountered on the path from source to destination for each flow. This setup determines the entire path from source ToR to destination ToR for each data flow, ensuring that traffic is distributed efficiently across the network.

The allocation process can be illustrated with specific paths determined in the example:
Flow f1: T1→S1→C1→S3→T3
Flow f2: T7→S8→C3→S4→T4
Flow f3: T7→S7→C1→S5→T6
Flow f4: T1→S2→C4→S6→T6

Notably, the first-stage coordinator may track all concurrent elephant flows in the network, as shown in FIG. 8A. However, a key advantage of this approach is that the first-stage coordinator does not need to provide complete path information for each flow, thereby avoiding the need for a source routing mechanism, which would require significant memory overhead in ToR switches, or for informing all switches along the path, which would result in high traffic overhead. This efficient coordination mechanism helps manage the complex routing tasks in a three-tier network topology while maintaining optimal performance and scalability.

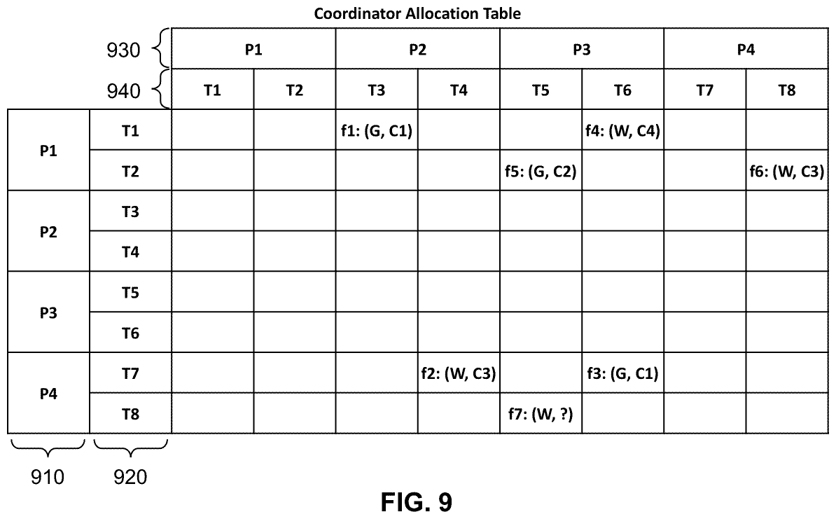

FIG. 9 illustrates an alternative coordinator allocation table used for managing data flows within a centralized solution for a three-tier network topology. In this configuration, as shown in FIGS. 6 and 7, the network also comprises a plurality of leaf switches and spine switches, which are organized into a plurality of pods, each pod containing at least two leaf switches and at least two spine switches. The purpose of the coordinator allocation table is to determine the routing of flows through these pods and across the network using a centralized decision-making process.

The coordinator allocation table shown in FIG. 9 includes a column and a row of the source and destination ToR switches (T1 to T8) 920, 940, respectively. Additionally, the table outlines source and destination pods (P1, P2, P3, and P4), indicated by 910 and 930, respectively. Each cell in the table corresponds to a possible route between a pair of ToR switches and contains two values: a color code representing the block (Grey “G” or White “W”) and a Core switch identifier (e.g., C1, C2, C3, C4).

In the centralized solution depicted in FIG. 9, the control packet is transmitted to a centralized coordinator switch, which is one of the core switches, to determine the optimal route for each data flow. The coordinator uses the table to allocate each flow to a specific color block and core switch based on network conditions and routing constraints.

For example, flow f1 is routed from T1 to T3 using the Grey block (“G”) and core switch C1, while flow f2 is routed from T7 to T4 using the White block (“W”) and core switch C3. The table illustrates the constraints that should be adhered to during the allocation process: each color can appear only once per ToR row or column, and each core switch ID can appear only once per pod row or column (double width), ensuring that the network resources are evenly distributed and preventing conflicts.

However, the table also demonstrates a potential issue with flow f7, which needs to be routed from T8 to T5. There is no available core switch that can be assigned to flow f7 without violating the constraints of the allocation table. To resolve this, an adjustment is necessary. One possible solution is to reallocate flow f2 to use core switch C4 instead of C3, changing its allocation to (W, C4). This change would free up core switch C3, allowing flow f7 to be assigned an available core switch, thereby accommodating all data flows without any conflicts.

### Embodiment 4: Multi-Link Leaf-Spine

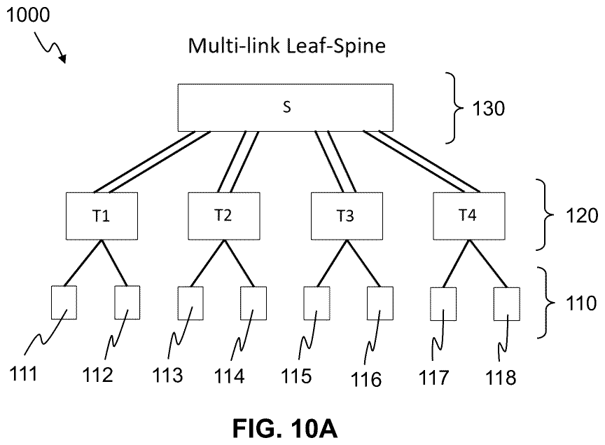

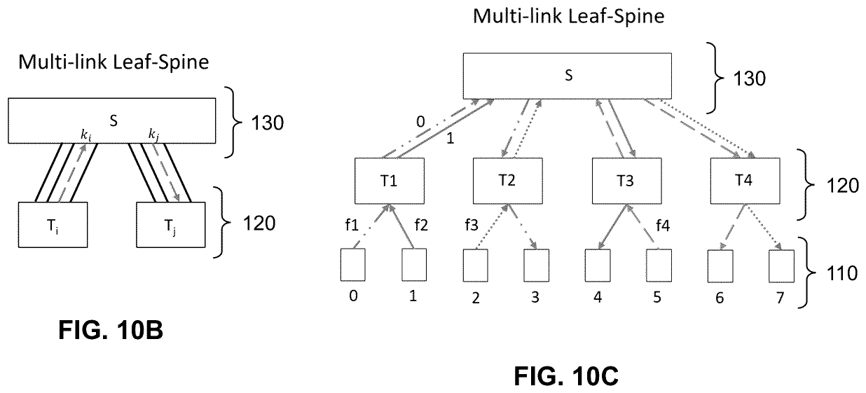

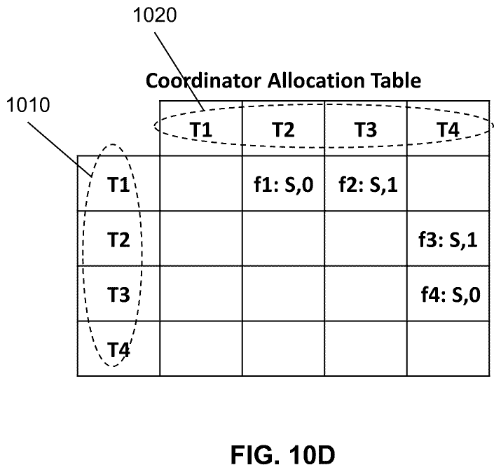

FIGS. 10A-10D collectively illustrate a multi-link leaf-spine network topology and demonstrate how the loop algorithm is adapted for such a topology.

FIG. 10A shows a network topology 1000 comprising two tiers: the server nodes 110 include server nodes 111-118, the first tier 120 includes leaf switches T1, T2, T3, and T4, and the second tier 130 includes a single spine switch S. The figure illustrates a multi-link leaf-spine topology, where each leaf switch is connected to the spine switch via multiple physical links. This multi-link configuration allows for simultaneous data transmission along multiple routes between each pair of leaf and spine switches, thereby increasing network capacity and resilience.

FIG. 10B provides a detailed view of a specific scenario within the multi-link leaf-spine topology. It demonstrates the method used by the spine switch S to select the appropriate link for forwarding a data flow to a destination leaf switch Tⱼ. When a data flow originates from a source leaf switch Tᵢ on the nth link of a total of m links between Tᵢ and spine S, the spine switch may assign the same nth link for the flow to exit towards the destination leaf switch Tⱼ. This method ensures consistent and predictable routing for data flows based on the link index.

FIG. 10C further illustrates the multi-link leaf-spine topology, detailing how multiple links between leaf switches T1-T4 and the spine switch S are used to handle different data flows f1, f2, f3, and f4. Each flow is assigned a specific link index, determining its path through the network. This assignment ensures that data flows are distributed evenly across available links, preventing congestion and optimizing the use of network resources.

FIG. 10D depicts the coordinator allocation table used in this multi-link leaf-spine topology. The table (1010 for the column, 1020 for the row) records the allocation of flows to specific spine switches and link indices. For example, flow f1 is assigned to spine S using link index 0, while flow f2 is assigned to spine S using link index 1. This allocation ensures that each spine-link combination (spine ID, link index) appears only once per row or column, maintaining the constraints necessary for balanced network load distribution.

The figures collectively illustrate how the network can dynamically allocate flows based on current traffic conditions and available links, using the coordinator allocation table to manage assignments effectively. The loop algorithm is extended to accommodate multi-link scenarios, where each data flow's route is determined by both the spine switch and the specific link it should use.

It should be understood that the above four embodiments are described to demonstrate the working principles of the network management and load balancing techniques described herein. However, other architectures are also possible, offering further flexibility and scalability. For instance, a more complex network design may incorporate three or even more tiers, as described in Embodiment 3, involving multiple levels of core, spine, and leaf switches to enhance network scalability and redundancy. Furthermore, the network may utilize multiple layers, as in Embodiment 2, allowing for concurrent data transmissions and more efficient resource allocation across different segments. Additionally, the architecture may incorporate multi-link connections between switches, as detailed in Embodiment 4, providing multiple parallel paths to increase bandwidth and fault tolerance. These features—multi-tier structures, multi-layer configurations, and multi-link capabilities—can be selectively combined and tailored to meet specific network requirements, ensuring a highly adaptable and robust network architecture capable of handling a diverse range of operational scenarios.

The present disclosure provides substantial benefits in enhancing the functionality and efficiency of computer networks, particularly within data center environments where high data throughput and reliable connectivity are essential. By employing a centralized and coordinated load balancing (CLB) mechanism, the solution optimizes the distribution of data flows across various network paths, thereby reducing congestion and improving overall network performance. This coordinated approach ensures that each data flow is dynamically assigned to the most suitable path based on real-time traffic conditions, which prevents bottlenecks and maximizes the utilization of available network resources.

An important advantage of the solution of the present disclosure is its ability to adapt to varying network loads and flow characteristics, such as differentiating between mice flows and elephant flows. By distinguishing these flow types, the solution allows for more precise and efficient routing decisions, with smaller, delay-sensitive flows being managed using stochastic load balancing techniques, and larger, bandwidth-intensive flows being handled through a deterministic loop algorithm. This targeted handling of different flow types enhances the network's capability to effectively manage diverse data traffic, ensuring low latency for critical tasks while maintaining high throughput for data-intensive operations.

Furthermore, the solution of the present disclosure addresses several technical challenges associated with complex network architectures, including multi-tier and multi-link topologies. By extending the loop algorithm to accommodate multiple layers, links, and tiers, the solution allows the network to maintain optimal performance even in more intricate configurations. This scalability benefits modern data centers that support increasing data volumes and increasingly sophisticated applications. The ability of the solution to dynamically adjust to network changes, such as the introduction of new flows or varying link conditions, ensures continuous optimization and resilience against potential disruptions.

In practical applications, the solution of the present disclosure is integrated into network management systems to address the technical problem of inefficient data routing and congestion in high-density network environments. Utilizing a centralized coordinator to manage load balancing decisions reduces the overhead associated with decentralized or manual routing adjustments, enabling faster and more accurate decision-making while minimizing the computational burden on individual switches. This not only improves the efficiency of network operations but also enhances the overall reliability and robustness of the computer network, making it more capable of supporting critical applications and services.

### Simulation Results

This section presents simulation results comparing the performance of the proposed Looping-based Load Balancing (LB) scheme against a reference scheme, “LBN.” The simulations were conducted across various test cases and network topologies to evaluate the efficiency and adaptability of the Looping-based LB mechanism under different network conditions.

The test cases involved both “Shuffle” and “no-Shuffle” scenarios. In the “no-Shuffle” scenario, all server nodes under one ToR switch communicate sequentially with all server nodes under another ToR switch. For example, the first server node under ToR Tᵢ communicates with the first server node under ToR Tⱼ, the second server node under ToR Tᵢ communicates with the second server node under ToR Tⱼ, and so forth. Conversely, the “Shuffle” scenario allows any source-destination (src, dst) host pair to communicate with each other in a randomized order, representing a more dynamic communication pattern.

Various fat-tree network topologies were tested, including configurations such as 64 ports with 128 hosts, 128 ports with 8192 hosts, and other intermediate configurations like 16 ports with 128 hosts and 64 ports with 2048 hosts. These topologies represent a range of network sizes and complexities, allowing for the assessment of the scalability and robustness of the looping-based LB scheme.

The table below summarizes the simulation results:

| Test Case | Results |
|---|---|
| DML All-reduce “Shuffle” and | Looping-based CLB achieved |
| “no-Shuffle” test cases including | throughput greater than 90% |
| (AlexNet, Googlenet, Resnet, Simplenet, | of the optimal solution for |
| Vgg) for 64ports_128hosts, 16ports_128hosts, | all test cases (“Shuffle” |
| 64ports_2048hosts, and | and “no-Shuffle”). In |
| 128ports_8192hosts topologies | contrast, LBN demonstrated |
| | poor performance, achieving |
| | as low as 29% of the optimal |
| | throughput, particularly |
| | in “Shuffle” scenarios. |
| 200 MB MPI_Allreduce_RecursiveHD | Looping-based CLB maintained |
| Shuffle and No-Shuffle (128, 512, | throughput above 90% of the |
| and 2048 hosts)* | optimal for all test cases. |
| | LBN performed poorly in the |
| | “Shuffle” scenarios, |
| | achieving as low as 27% of |
| | the optimal throughput. |
| MPI_Alltoall 10 MB No-Shuffle* | Looping-based CLB and LBN |
| | achieved similar throughput. |
| Slow-Node problem assuming Shuffle and no- | For “no-Shuffle” |
| Shuffle MPI_Allreduce_RecursiveHD_looping | scenarios, both Looping-based |
| for 64 and 128 ranks and nodes are | CLB and LBN showed |
| “synchronized” and “asynchronized | comparable performance, |
| (nodes have random starting times [0, | with minimal impact from |
| 100] μs)”* | slow nodes. In “Shuffle” |
| | scenarios, looping-based CLB |
| | outperformed LBN by 175% and |
| | 139% when nodes were |
| | synchronized. When nodes |
| | were asynchronous, the |
| | Looping-based CLB |
| | outperformed LBN by 100% |
| | and 78%. |
| Double-Binary-Tree Transmission* | Looping-based CLB achieved |
| | throughput similar to ECMP |
| | and outperformed LBN by up |
| | to 14%. |

*For certain test cases, to minimize the impact of out-of-order delivery caused by changes in flow paths (as directed by the Coordinator), the communication pattern between server nodes was preloaded into the Coordinator to execute the Looping algorithm. Consequently, all ToR switches' forwarding tables were pre-configured with the flow entries and their corresponding egress ports based on the Looping algorithm's outcomes.

The simulation results demonstrate the effectiveness of the Looping-based LB scheme across various network conditions and topologies. The scheme consistently achieves high throughput close to the optimal solution and outperforms the LBN scheme, particularly in complex communication scenarios like the “Shuffle” test cases. The ability to maintain high performance despite changes in network traffic patterns and configurations highlights the robustness and adaptability of the Looping-based LB mechanism, making it a valuable tool for managing data flows in modern data center environments.

It should be understood that various modifications, alterations, and adaptations may be made to the specific elements and configurations disclosed, including but not limited to dimensions, materials, positions, and operational mechanisms, without departing from the essence and scope of the disclosure.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or part of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is only for the purpose of describing particular embodiments and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

While every effort has been made to provide a detailed and accurate description of the disclosure herein, it should be noted that the scope of the disclosure is not limited to the exact configurations and embodiments described. The description provided is intended to illustrate the principles of the disclosure and not to limit the disclosure to the specific embodiments illustrated. It is intended that the scope of the disclosure be defined by the appended claims, their equivalents, and their potential applications in other fields.

What is claimed is:

1. A method for routing data in a multi-tier network architecture, comprising:
transmitting a data flow to a source leaf switch of a plurality of leaf switches in the multi-tier network architecture, the data flow comprising a sequence of data packets;
determining if an intended route for the data flow exists in a forwarding table stored at the source leaf switch using routing metadata from at least one of the data packets;
in response to determining that the intended route does not exist in the forwarding table, transmitting a control packet to a centralized coordinator switch;
modifying an allocation table stored at the centralized coordinator switch to include an updated route for the data flow based on current network conditions;
updating the forwarding table stored at the source leaf switch using the updated route; and
transmitting the data flow to a destination node according to the updated forwarding table.

2. The method of claim 1, wherein modifying the allocation table comprises utilizing a loop algorithm to determine the updated route for the data flow.

3. The method of claim 1, further comprising:
classifying the data flow as a mice flow or an elephant flow based on a size of the data flow; and
in response to the data flow being classified as the mice flow, routing the data flow according to an Equal-Cost Multi-Path (ECMP) or Hop-by-hop Utilization-aware Load balancing Architecture (HULA) scheme.

4. The method of claim 1, wherein the multi-tier network architecture comprises a first tier and a second tier, the first tier comprising the plurality of leaf switches and the second tier comprising a plurality of spine switches, the centralized coordinator switch being one of the plurality of spine switches.

5. The method of claim 1, wherein the multi-tier network architecture comprises a plurality of layers to allow simultaneous data transmission via a same route on corresponding layers, and
wherein the allocation table further comprises a sending layer table and a receiving layer table for determining which of the plurality of layers the data flow is to use.

6. The method of claim 1, wherein the multi-tier network architecture comprises a first tier comprising the plurality of leaf switches, a second tier comprising a plurality of spine switches, and a third tier comprising a plurality of core switches, the centralized coordinator switch being one of the plurality of core switches.

7. The method of claim 6, wherein:
a first number of the spine switches and a first number of the core switches are grouped as a first group, and a second number of the spine switches and a second number of the core switches are grouped as a second group, and
the control packet comprises a first control packet and a second control packet, the first control packet being transmitted to the centralized coordinator switch acting as a first-stage coordinator for determining whether the first group or the second group is included in the updated route, the second control packet being transmitted to one of the core switches in the determined first or second group acting as a second-stage coordinator for determining which of the plurality of core switches is included in the updated route.

8. The method of claim 6, wherein:
the plurality of leaf switches and the plurality of spine switches are grouped as a plurality of pods, each comprising at least two of the plurality of leaf switches and at least two of the plurality of spine switches, and
the control packet is transmitted to the centralized coordinator switch for determining which of the plurality of pods are included in the updated route.

9. The method of claim 1, wherein:
the multi-tier network architecture comprises a first tier and a second tier, the first tier comprising the plurality of leaf switches and the second tier comprising a plurality of spine switches,
the multi-tier network architecture comprises a plurality of physical links between each of the plurality of the leaf switches and each of the plurality of spine switches to allow simultaneous data transmission via a same route on corresponding physical links, and
the allocation table further comprises a link index for determining which of the plurality of physical links the data flow is to use.

10. The method of claim 1, further comprising:
in response to completing the transmission of the data flow,
retaining the forwarding table for a predetermined period; and
erasing information on the data flow from the allocation table to free up resources for future routing tasks.

11. A network system comprising:
a plurality of leaf switches and a centralized coordinator switch, the leaf switches and the centralized coordinator switch being part of a multi-tier network architecture;
wherein a source leaf switch of the plurality of leaf switches comprises:
a packet receiver for receiving a data flow comprising a sequence of data packets;
a leaf storage unit, in which a forwarding table is stored; and
a leaf control unit adapted to determine if an intended route for the data flow exists in the forwarding table using routing metadata from at least one of the data packets, and, in response to determining that the intended route does not exist in the forwarding table, to generate a control packet that is to be transmitted to the centralized coordinator switch;
wherein the centralized coordinator switch comprises:
a coordinator storage unit, in which an allocation table is stored; and
a coordinator control unit adapted to modify the allocation table to include an updated route for the data flow based on current network conditions, and to transmit the updated route to the source leaf switch; and
wherein the leaf control unit of the source leaf switch is further adapted to update the forwarding table using the updated route, and to transmit the data flow to a destination node according to the updated forwarding table.

12. The network system of claim 11, wherein the allocation table is modified by utilizing a loop algorithm to determine the updated route for the data flow.

13. The network system of claim 11, wherein the source leaf switch further comprises a classification unit configured to classify the data flow as a mice flow or an elephant flow based on a size of the data flow; and
wherein the data flow is routed according to an Equal-Cost Multi-Path (ECMP) or Hop-by-hop Utilization-aware Load balancing Architecture (HULA) scheme in response to the data flow being classified as the mice flow.

14. The network system of claim 11, wherein the multi-tier network architecture comprises:
a first tier comprising the plurality of leaf switches; and
a second tier comprising a plurality of spine switches, wherein the centralized coordinator switch is one of the plurality of spine switches.

15. The network system of claim 11, wherein the multi-tier network architecture comprises:
a plurality of layers for allowing simultaneous data transmission via a same route on corresponding layers,
wherein the allocation table further comprises a sending layer table and a receiving layer table for determining which of the plurality of layers the data flow is to use.

16. The network system of claim 11, wherein the multi-tier network architecture comprises:
a first tier comprising the plurality of leaf switches;
a second tier comprising a plurality of spine switches; and
a third tier comprising a plurality of core switches,
wherein the centralized coordinator switch is one of the plurality of core switches.

17. The network system of claim 16, wherein:
a first number of the spine switches and a first number of the core switches are grouped as a first group, and a second number of the spine switches and a second number of the core switches are grouped as a second group, and
the control packet comprises a first control packet and a second control packet, the first control packet being transmitted to the centralized coordinator switch acting as a first-stage coordinator for determining whether the first group or the second group is included in the updated route, the second control packet being transmitted to one of the core switches in the determined first or second group acting as a second-stage coordinator for determining which of the plurality of core switches is included in the updated route.

18. The network system of claim 16, wherein:
the plurality of leaf switches and the plurality of spine switches are grouped as a plurality of pods, each pod comprising at least two of the plurality of leaf switches and at least two of the plurality of spine switches, and
the control packet is transmitted to the centralized coordinator switch for determining which of the plurality of pods are included in the updated route.

19. The network system of claim 11, wherein:
the multi-tier network architecture comprises a first tier and a second tier, the first tier comprising the plurality of leaf switches and the second tier comprising a plurality of spine switches,
the multi-tier network architecture comprises a plurality of physical links between each of the plurality of the leaf switches and each of the plurality of spine switches to allow simultaneous data transmission via a same route on corresponding physical links, and
the allocation table further comprises a link index for determining which of the plurality of physical links the data flow is to use.

20. An apparatus comprising:
a coordinator storage unit, in which an allocation table is stored; and
a coordinator control unit adapted to:
receive a control packet from a source leaf switch of a plurality of leaf switches in a multi-tier network architecture, the control packet being generated in response to the source leaf switch determining that an intended route for a data flow comprising a sequence of data packets does not exist in a forwarding table stored at the source leaf switch using routing metadata from at least one of the data packets;
modify the allocation table to include an updated route for the data flow based on current network conditions; and
transmit the updated route to the source leaf switch.
